(19) United States
(12) Patent Application Publication
(10) Pub. No.: US 2008/0296291 A1
(43) Pub. Date: Dec. 4, 2008

(54) Warm Wave Generating System

(76) Inventors: Hiromi Nanba, Tokyo (JP); Masaaki Harita, Tochigi (JP)

Correspondence Address: KEVIN J. MCNEELY, ESQ., 5335 WISCONSON AVENUE, NW, SUITE 440, WASHINGTON, DC, 20015, US

(21) Appl. No.: 11/915,849

(22) PCT Filed: Jun. 5, 2006
(86) PCT No.: PCT/JP2006/311191

§ 371 Date: May 20, 2008

(30) Foreign Application Priority Data
Jun. 6, 2005 (JP) 2005-165152

(51) Int. Cl. H05B 6/04

(52) U.S. Cl. 219/660

(57) ABSTRACT

A warm wave generating system includes a direct-current power supply, a frequency generator to output a variable signal wave at a predetermined frequency range, a transformer in which a primary coil through which a direct current outputted from the direct-current power supply can pass is opposed to a secondary coil through which the signal wave outputted from the frequency generator can pass, and a heating element connected to the direct-current power supply via the primary coil of the transformer. The direct current, which is modulated by the signal wave passing through the primary coil of the transformer and then through the secondary coil, is used to allow the heating element to generate heat.

### CROSS REFERENCE TO RELATED APPLICATIONS

This U.S. national phase entry application claims priority to international patent application PCT/JP2006/311191 filed on filed on Jun. 5, 2006, and Japanese patent application 2005-165152 filed on Jun. 6, 2005 filed on, which are incorporated by reference herein.

### FIELD OF THE INVENTION

The present invention relates to a warm wave generating system for generating far-infrared radiant heat from a heating element.

### BACKGROUND OF THE INVENTION

Traditionally, a warm wave generating system generates far-infrared radiant heat (it is referred to as “warm wave” hereinafter) by flowing current into the heating element to cure or help to heal an injured part of the human body by irradiating it with the warm wave.

However, the above-mentioned prior warm wave generating system uses an alternating-current power supply. There is some risk that the heating element of the prior warm wave generating system may generate an electromagnetic wave at a hazardous level for a human body.

Therefore there is a possibility to set the heating element for the alternating-current power supply to alternate between positive pole side and negative pole side to use the heating element for the alternating-current power supply by direct current. However, in this case, there is a problem that it is impractical since there is a character that the positive pole side generates heat and the negative pole side does not generate heat and temperature distribution between the positive pole side and the negative pole side differs significantly.

In addition, it takes a long time for the heating element to reach a desired temperature in case where the relative density of the heating element is used to compensate the difference of the temperature distribution.

And there is also a problem that it may be impossible to obtain a sufficient healing effect since the warm wave generating system cannot generate warmth efficiently.

In order to overcome the above problems, the object of the present invention is to provide a warm wave generating system to be able to generate a harmless warm wave for the human body efficiently.

### SUMMARY OF THE INVENTION

In order to achieve the above objects, a warm wave generating system of the present invention comprises a direct-current power supply, a frequency generator to output a variable signal wave at a predetermined frequency range a transformer in which a primary coil through which a direct current outputted from the direct-current power supply can pass is opposed to a secondary coil through which the signal wave outputted from the frequency generator can pass, a heating element connected to the direct-current power supply via the primary coil of the transformer, wherein the direct current, which has been modulated by the signal wave passing through the primary coil of the transformer and then through the secondary coil thereof, is used to allow the heating element to generate heat.

Preferably, the primary coil of the transformer may be connected to the positive pole side of the direct-current power supply.

In addition, the heating element may comprise a paint coating that includes a nickel-indium compound oxide onto an upper surface plane of a polyester film.

Electrodes may be solderlessly connected at two ends of the plane.

Furthermore, the heating element may be configured in the shape of band, and a number of heating elements are installed on a cushion in parallel at a predetermined distance.

Furthermore, the frequency generator may be an audio device, such as, for example, a consumer electronic device that plays compact discs (CDs.)

The audio device may comprise an amplifier that is connected to a headphone.

### BRIEF DESCRIPTION OF THE DRAWINGS

FIG. 1 is a schematic of a warm wave generating system according to the present invention;

FIG. 2 is a perspective view of a part of inside structure of a bed incorporated a heating element of a warm wave generating system of the present invention;

FIG. 3 is a perspective view of a bed that incorporates a heating element of a warm wave generating system of the present invention.

### DESCRIPTION OF THE PREFERRED EMBODIMENT

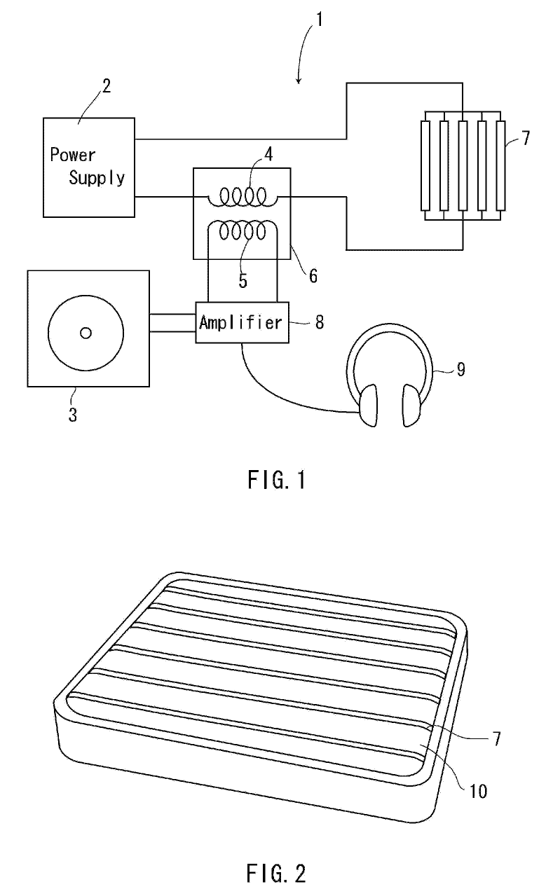

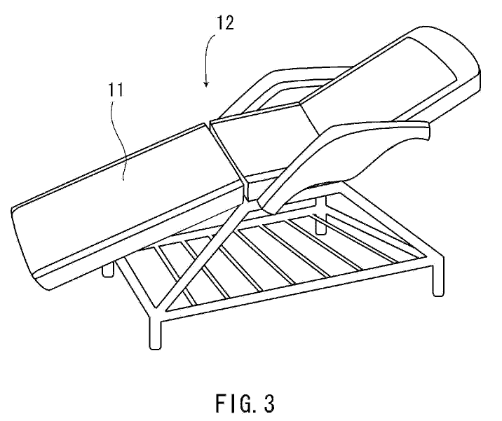

An embodiment of the present invention is described below with reference to FIGS. 1 to 3. FIG. 1 is a schematic of a warm wave generating system according to the present invention, FIG. 2 is a perspective view of a part of the inside structure of a bed that incorporates a heating element of a warm wave generating system of the present invention, and FIG. 3 is a perspective view of a bed that incorporates a heating element of a warm wave generating system of the present invention.

As shown in FIG. 1, the warm wave generating system 1 according to the present invention comprises a direct-current power supply 2, a frequency generator 3 to output a variable signal wave at a predetermined range of frequency, a transformer 6 with a primary coil 4 to modulate direct current output from the direct-current power supply 2 with the signal wave output from the frequency generator 2.

The direct-current power supply 2 has a fuse to limit current to about 6 ampere current below 12 volt at the working voltage safely. Preferably, the side of the primary coil 4 of the transformer 6 is connected to the positive pole side of the direct-current power supply 2.

The frequency generator 3 is an apparatus such as a compact disc player to be able to play music from a CD or a CD-ROM. The frequency generator 3 has a volume switch (not shown) to be able to change a frequency at a predetermined frequency range and a jack (not shown) to be able to connect all kinds of sound sources such as an electrophone or a frequency transmitter so as to be able to change over to input from all kinds of sound sources via this jack. In addition, the frequency generator 3 has an audio amplifier to output 6 to 10 watt for example as an amplifier, and a headphone 9 can be connected to this amplifier 8 via an earphone jack (not shown).

Preferably, the heating element may use one described in patent pending (JP2003-137964). This heating element is configured by coating laminated polyester with paint comprising nickel-indium compound oxide onto an upper surface plane of a polyester film and power supply electrodes solderlessly connected at two ends of the plane.

As shown in FIG. 2, this heating element is formed in the shape of band and it is laminated by vinyl chloride resin. A number of heating elements are installed in parallel at a predetermined distance on an insulation sheet (an aluminum paper) 10 which is installed on a low reaction cushion made of urethane material 40 mm thick. A high reaction cushion made of chip material 15 mm thick installed on veneer (not shown) is installed under the low reaction cushion. On the other hand, a cushion made of sponge 15 mm thick is installed on the low reaction cushion and the top surface and the side surface of the cushion made of sponge are covered by vinyl leather 11 for a cover. Thus an aesthetic bed 12 is configured.

In addition, although at the preferred embodiment of the present invention 69 kinds of frequency warm wave for 30 seconds generate for 34 minutes and 30 seconds totally, the kinds and time of the frequency generated can be changed to match with affection and disease of a patient.

Operation of the warm wave generating system 1 according to the embodiment of the present invention is described below.

To begin with, the direct-current power supply 2 is switched on so that direct current may pass through the primary coil 4 of the transformer 6 to pass the current to the heating element 7. The signal wave fluctuating within the predetermined range is output from the frequency generator 3. The patient lies on the bed 12 and with the headphones 9 on his or her head. The volume control of the frequency generator 3 is operated to set the sound to the predetermined level. After the signal wave is amplified by the amplifier 8, it passes through the secondary coil 5 of the transformer 6. And the signal wave that passed through the secondary coil 5 modulates the direct current passing through the primary coil 4 so that the modulated direct current may pass through the heating element 7. As a result, the warm wave is irradiated against the patient from the heating element 7 to expand blood vessels in the body of the patient to improve bloodstream flow so that the patient can obtain experience the curing or healing effect.

Generally, the human body has faint electric potential and each organ in the human body functions at the potential pulse. The organ disorders in the case that this electric potential is not transmitted. The human body ages by stock of oxidation action in the process of life support. However, as mentioned above it is possible to irradiate the warm wave generated from the heating element 7 to the patient by passing through the modulated direct current and take it in the patient's body to neutralize oxidation in the body to improve metabolism and reduce aging symptoms.

In addition, although at the aforementioned preferred embodiment of the present invention the cure is carried out under the condition to put the headphone 9 on the patient to obtain effect by music cure, the headphone 9 may be not necessarily put on the patient in all cases.

And also the shape and position of the heating element 7 are not limited to the above case, but they may be modified to other shapes and positions. Furthermore, the heating element 7 may be incorporated into an electric carpet or an electric mat and the like besides the aesthetic bed 12.

According to the present invention, it is possible to generate the harmless warm wave for the human body having frequency level to match the affection and disease of each patient since the warm wave generating system uses the direct-current power supply and the frequency generator to be able to output a variable signal wave at a predetermined frequency range.

Furthermore, it is possible to generate the warm wave from the heating element 7 by passing through the modulated direct current and take it in the patient's body to expand blood vessels in the body of the patient to improve metabolism and reduce aging symptom and the like.

What is claimed is:

1. A warm wave generating system comprising:
a direct-current power supply;
a frequency generator to output a variable signal wave at a predetermined frequency range;
a transformer in which a primary coil through which a direct current outputted from the direct-current power supply can pass is opposed to a secondary coil through which the signal wave outputted from the frequency generator can pass;
a heating element connected to the direct-current power supply via the primary coil of the transformer;
wherein the direct current, which has been modulated by the signal wave passing through the primary coil of the transformer and then through the secondary coil thereof, is used to allow the heating element to generate heat.

2. The warm wave generating system according to claim 1, wherein the primary coil of the transformer is connected to the positive pole side of the direct-current power supply.

3. The warm wave generating system according to claim 1, wherein the heating element comprises:
a paint coating that includes a nickel-indium compound oxide onto an upper surface plane of a polyester film.

4. The warm wave generating system according to claim 3, further comprising:
electrodes solderlessly connected at two ends of the plane.

5. The warm wave generating system according to claim 3, wherein the heating element is configured in the shape of a band, and a number of heating elements are installed on a cushion in parallel at a predetermined distance.

6. The warm wave generating system of claim 1, wherein the frequency generator comprises an audio device to play music.

7. The warm wave generating system according to claim 6, wherein the audio device comprises an amplifier that is connected to a headphone.
